(19) United States
(12) Patent Application Publication
(10) Pub. No.: US 2017/0030289 A1
(43) Pub. Date: Feb. 2, 2017

(54) CYLINDER BORE WALL HEAT INSULATION DEVICE, INTERNAL COMBUSTION ENGINE AND VEHICLE

(71) Applicants: NICHIAS CORPORATION, Tokyo (JP); TOYOTA JIDOSHA KABUSHIKI KAISHA, Toyota-shi, Aichi (JP)

(72) Inventors: Satoshi OKAWA, Toyota-shi (JP); Tetsu YAMADA, Toyota-shi (JP); Takashi KURAUCHI, Toyota-shi (JP); Shinpei YAMASHITA, Ikeda-shi (JP); Kazuaki NISHIO, Hamamatsu-shi (JP); Yoshifumi FUJITA, Hamamatsu-shi (JP); Yoshihiro KAWASAKI, Hamamatsu-shi (JP)

(21) Appl. No.: 15/302,700

(22) PCT Filed: Apr. 2, 2015
(86) PCT No.: PCT/JP2015/060505

§ 371 Date: Oct. 7, 2016

(30) Foreign Application Priority Data
Apr. 11, 2014 (JP) 2014-081569

(51) Int. Cl. F02F 1/14

(52) U.S. Cl. CPC F02F 1/14

(57) ABSTRACT

A cylinder bore wall thermal insulator includes a rubber member that comes in contact with half of a cylinder bore-side wall surface of a middle-lower part of a groove-like coolant passage, and has a contact surface having a shape that conforms to the shape of the cylinder bore-side wall surface of the middle-lower part of the groove-like coolant passage, a metal base member on which the rubber member is secured, and an elastic member that is provided to the metal base member, and biases the metal base member so that the metal base member presses the rubber member against the cylinder bore-side wall surface of the middle-lower part of the groove-like coolant passage. An internal combustion engine in which a cylinder bore wall has a uniform temperature can be provided by utilizing the cylinder bore wall thermal insulator.

### TECHNICAL FIELD

The present invention relates to a thermal insulator that is disposed to come in contact with the surface of a cylinder bore wall that forms a cylinder block included in an internal combustion engine and defines a groove-like coolant passage, an internal combustion engine that includes the thermal insulator, and an automobile that includes the internal combustion engine.

### BACKGROUND ART

An internal combustion engine is designed so that fuel explodes within the cylinder bore when the piston is positioned at top dead center, and the piston is moved downward due to the explosion. Therefore, the upper part of the cylinder bore wall increases in temperature as compared with the middle-lower part of the cylinder bore wall. Accordingly, a difference in the amount of thermal deformation occurs between the upper part and the middle-lower part of the cylinder bore wall (i.e., the upper part of the cylinder bore wall expands to a large extent as compared with the middle-lower part of the cylinder bore wall).

As a result, the frictional resistance of the piston against the cylinder bore wall increases, and the fuel consumption increases. Therefore, a reduction in difference in the amount of thermal deformation between the upper part and the middle-lower part of the cylinder bore wall has been desired.

Attempts have been made to control the cooling efficiency in the upper part and the middle-lower part of the cylinder bore wall due to the coolant by disposing a spacer in a groove-like coolant passage to adjust the flow of the coolant in the groove-like coolant passage such that the cylinder bore wall has a uniform temperature. For example, Patent Literature 1 discloses an internal combustion engine heating medium passage partition member that is disposed in a groove-like heating medium passage formed in a cylinder block of an internal combustion engine to divide the groove-like heating medium passage into a plurality of passages, the heating medium passage partition member including a passage division member that is formed at a height above the bottom of the groove-like heating medium passage, and serves as a wall that divides the groove-like heating medium passage into a bore-side passage and a non-bore-side passage, and a flexible lip member that is formed from the passage division member in the opening direction of the groove-like heating medium passage, the edge area of the flexible lip member being formed of a flexible material to extend beyond the inner surface of one of the groove-like heating medium passages, the edge area of the flexible lip member coming in contact with the inner surface at a middle position of the groove-like heating medium passage in the depth direction due to the flexure restoring force after insertion into the groove-like heating medium passage to separate the bore-side passage and the non-bore-side passage.

### CITATION LIST

### Patent Literature

Patent Literature 1: JP-A-2008-31939 (claims)

### SUMMARY OF INVENTION

### Technical Problem

According to the internal combustion engine heating medium passage partition member disclosed in Patent Literature 1, since the temperature of the cylinder bore wall can be made uniform to a certain extent, the difference in the amount of thermal deformation between the upper area and the lower area of the cylinder bore wall can be reduced. However, a further reduction in the difference in the amount of thermal deformation between the upper area and the lower area of the cylinder bore wall has been desired.

An object of the invention is to provide an internal combustion engine in which the cylinder bore wall has a highly uniform temperature.

### Solution to Problem

The inventors conducted extensive studies in order to solve the above technical problem, and found that the temperature of the cylinder bore wall can be made uniform by disposing a rubber member that insulates the cylinder bore wall so as to come in contact with the cylinder bore wall that defines the groove-like coolant passage and prevent a situation in which the coolant comes in direct contact with the cylinder bore wall. This finding has led to the completion of the invention.

According to a first aspect of the invention, a cylinder bore wall thermal insulator is provided to a middle-lower part of a groove-like coolant passage of a cylinder block included in an internal combustion engine that includes a plurality of cylinder bores, and insulates half of a cylinder bore wall, the cylinder bore wall thermal insulator including:

a rubber member that comes in contact with half of a cylinder bore-side wall surface of the middle-lower part of the groove-like coolant passage, and has a contact surface having a shape that conforms to the shape of the cylinder bore-side wall surface of the middle-lower part of the groove-like coolant passage, a metal base member on which the rubber member is secured, and an elastic member that is provided to the metal base member, and biases the metal base member so that the metal base member presses the rubber member against the cylinder bore-side wall surface of the middle-lower part of the groove-like coolant passage,

the rubber member including an end bore rubber member that insulates part of the cylinder bore wall that surrounds an end bore that is situated on one end, and an end bore rubber member that insulates part of the cylinder bore wall that surrounds an end bore that is situated on the other end, or including an end bore rubber member that insulates part of the cylinder bore wall that surrounds an end bore that is situated on one end, an end bore rubber member that insulates part of the cylinder bore wall that surrounds an end bore that is situated on the other end, and one or more intermediate bore rubber members that respectively insulate part of the cylinder bore wall that surrounds an intermediate bore,

the metal base member being integrally formed to cover a range from the part of the cylinder bore wall that surrounds the end bore that is situated on one end to the part of the cylinder bore wall that surrounds the end bore that is situated on the other end, and

one or more elastic members being provided corresponding to each end bore metal base member and each intermediate bore metal base member.

According to a second aspect of the invention, a cylinder bore wall thermal insulator is provided to a middle-lower part of a groove-like coolant passage of a cylinder block included in an internal combustion engine that includes three or more cylinder bores, and insulates half of a cylinder bore wall, the cylinder bore wall thermal insulator including:

a rubber member that comes in contact with half of a cylinder bore-side wall surface of the middle-lower part of the groove-like coolant passage, and has a contact surface having a shape that conforms to the shape of the cylinder bore-side wall surface of the middle-lower part of the groove-like coolant passage, a metal base member on which the rubber member is secured, and an elastic member that is provided to the metal base member, and biases the metal base member so that the metal base member presses the rubber member against the cylinder bore-side wall surface of the middle-lower part of the groove-like coolant passage,

the rubber member including an end bore rubber member that insulates part of the cylinder bore wall that surrounds an end bore that is situated on one end, an end bore rubber member that insulates part of the cylinder bore wall that surrounds an end bore that is situated on the other end, and one or more intermediate bore rubber members that respectively insulate part of the cylinder bore wall that surrounds an intermediate bore,

the metal base member being integrally formed to cover a range from the part of the cylinder bore wall that surrounds the end bore that is situated on one end to the part of the cylinder bore wall that surrounds the end bore that is situated on the other end, and

one or more elastic members being provided corresponding to each end bore metal base member and each intermediate bore metal base member.

According to a third aspect of the invention, a cylinder bore wall thermal insulator is provided to a middle-lower part of a groove-like coolant passage of a cylinder block included in an internal combustion engine that includes two cylinder bores, and insulates half of a cylinder bore wall, the cylinder bore wall thermal insulator including:

a rubber member that comes in contact with half of a cylinder bore-side wall surface of the middle-lower part of the groove-like coolant passage, and has a contact surface having a shape that conforms to the shape of the cylinder bore-side wall surface of the middle-lower part of the groove-like coolant passage, a metal base member on which the rubber member is secured, and an elastic member that is provided to the metal base member, and biases the metal base member so that the metal base member presses the rubber member against the cylinder bore-side wall surface of the middle-lower part of the groove-like coolant passage,

the rubber member including an end bore rubber member that insulates part of the cylinder bore wall that surrounds an end bore that is situated on one end, and an end bore rubber member that insulates part of the cylinder bore wall that surrounds an end bore that is situated on the other end,

the metal base member being integrally formed to cover a range from the part of the cylinder bore wall that surrounds the end bore that is situated on one end to the part of the cylinder bore wall that surrounds the end bore that is situated on the other end, and

one or more elastic members being provided corresponding to each end bore metal base member.

According to a fourth aspect of the invention, an internal combustion engine includes the cylinder bore wall thermal insulator, the cylinder bore wall thermal insulator being provided to each of half of the cylinder bore-side wall surface of the middle-lower part of the groove-like coolant passage, and the other half of the cylinder bore-side wall surface of the middle-lower part of the groove-like coolant passage.

According to a fifth aspect of the invention, an internal combustion engine includes the cylinder bore wall thermal insulator, the cylinder bore wall thermal insulator being provided to only half of the cylinder bore-side wall surface of the middle-lower part of the groove-like coolant passage.

According to a sixth aspect of the invention, an automobile includes the internal combustion engine.

### Advantageous Effects of Invention

The aspects of the invention thus ensure that the cylinder bore wall of an internal combustion engine has a uniform temperature. This makes it possible to reduce the difference in the amount of thermal deformation between the upper part and the middle-lower part of the cylinder bore wall. The aspects of the invention can provide a thermal insulator that is rarely displaced in the groove-like coolant passage due to vibrations or the flow of the coolant.

### BRIEF DESCRIPTION OF DRAWINGS

FIG. 1 is a schematic plan view illustrating an example of a cylinder block in which a cylinder bore wall thermal insulator according to one embodiment of the invention is disposed.

FIG. 2 is a cross-sectional view taken along the line x-x illustrated in FIG. 1.

FIG. 3 is a perspective view illustrating the cylinder block illustrated in FIG. 1.

FIGS. 4A and 4B are schematic perspective views illustrating an example of a cylinder bore wall thermal insulator according to one embodiment of the invention.

FIG. 5 is a plan view (top view) illustrating the cylinder bore wall thermal insulator illustrated in FIGS. 4A and 4B.

FIG. 6 is a side view illustrating the cylinder bore wall thermal insulator (rubber member) illustrated in FIGS. 4A and 4B.

FIG. 7 is a side view illustrating the cylinder bore wall thermal insulator (metal base member) illustrated in FIGS. 4A and 4B.

FIG. 8 is a schematic view illustrating a state in which a cylinder bore wall thermal insulator (20) is provided to the cylinder block (11) illustrated in FIG. 1.

FIG. 9 is a schematic view illustrating a state in which two cylinder bore wall thermal insulators (20a, 20b) are provided to the cylinder block (11) illustrated in FIG. 1.

FIG. 10 is an end view taken along the line x-x illustrated in FIG. 9.

FIG. 11 is a schematic view illustrating an example of a method for producing a cylinder bore wall thermal insulator.

FIG. 12 is a schematic view illustrating an example of a method for producing a cylinder bore wall thermal insulator.

FIG. 13 is a schematic view illustrating an example of a method for producing a cylinder bore wall thermal insulator.

FIG. 14 is a schematic view illustrating an example of a method for producing a cylinder bore wall thermal insulator.

FIGS. 15A and 15B are schematic views illustrating an example of a method for producing a cylinder bore wall thermal insulator.

FIG. 16 is a schematic view illustrating another example of a cylinder bore wall thermal insulator according to one embodiment of the invention.

FIG. 17 is a schematic view illustrating an example of a coolant flow adjustment member.

FIG. 18 is a schematic view illustrating an example in which a cylinder bore wall thermal insulator includes a horizontal rib.

FIG. 19 is a schematic view illustrating an example in which a cylinder bore wall thermal insulator includes a vertical rib.

FIG. 20 is a schematic view illustrating another example of a method for providing an elastic member.

FIG. 21 is a schematic view illustrating still another example of a method for providing an elastic member.

### DESCRIPTION OF EMBODIMENTS

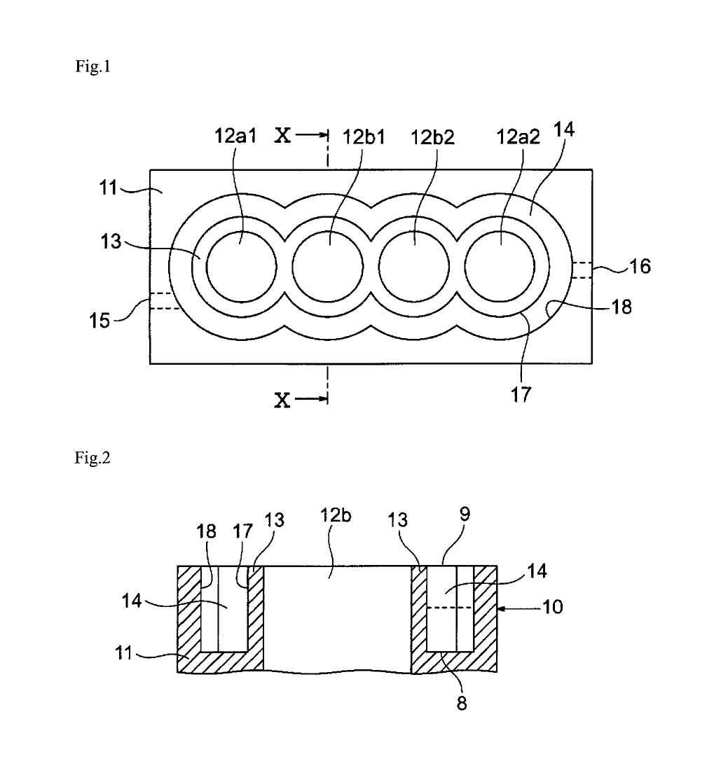

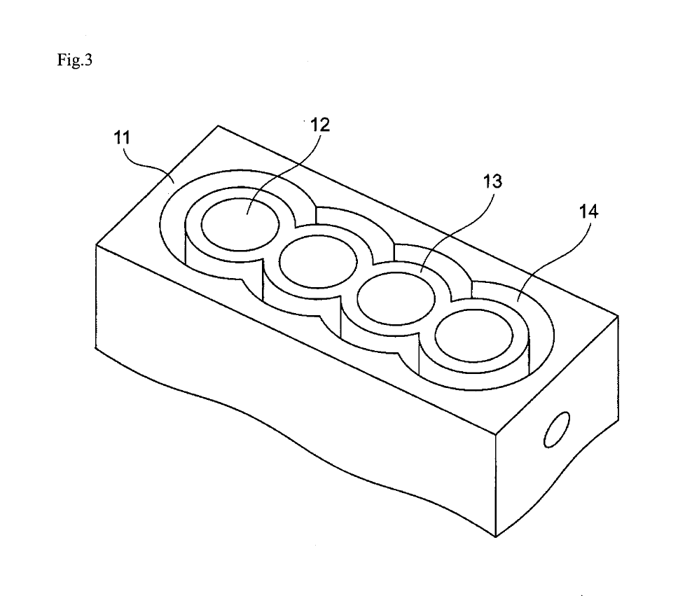

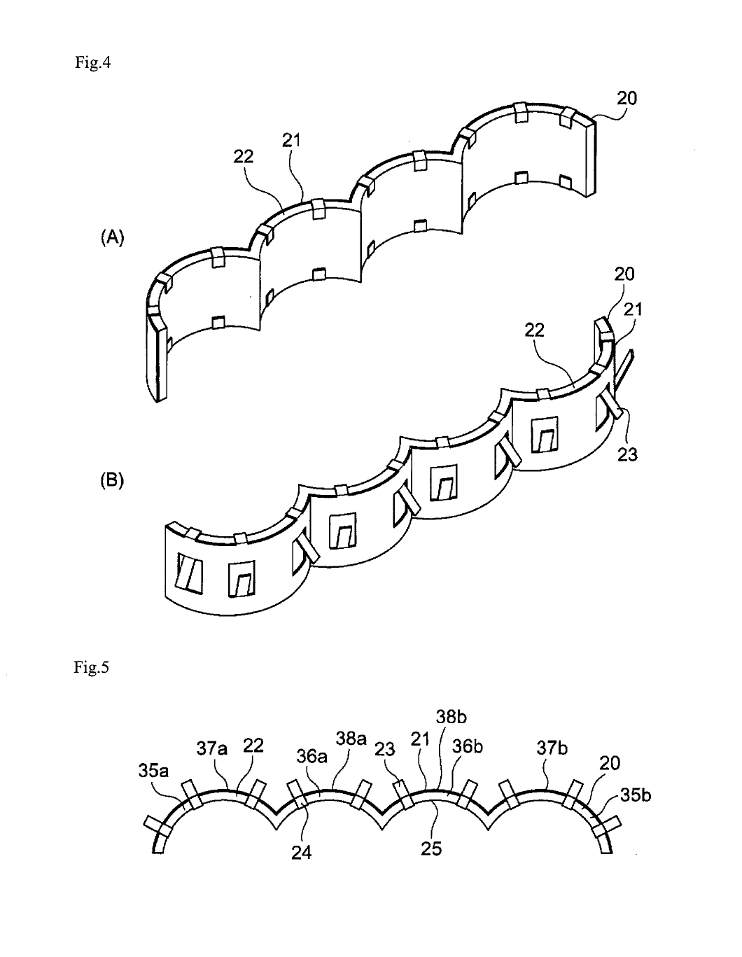

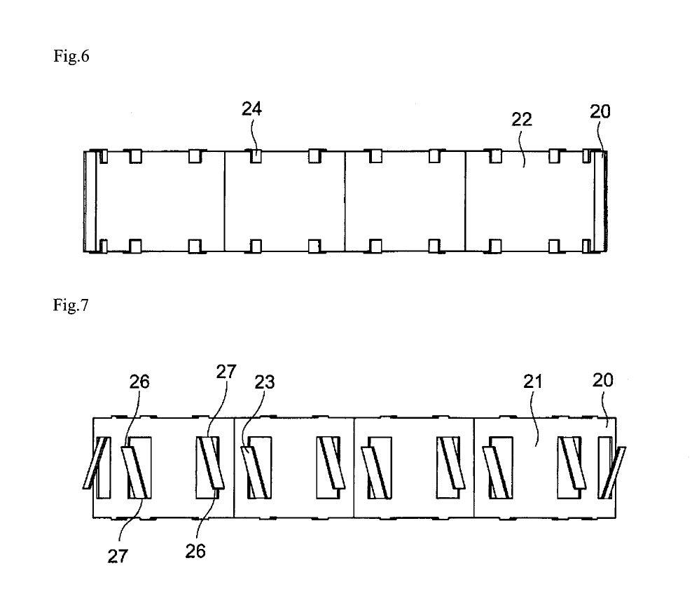

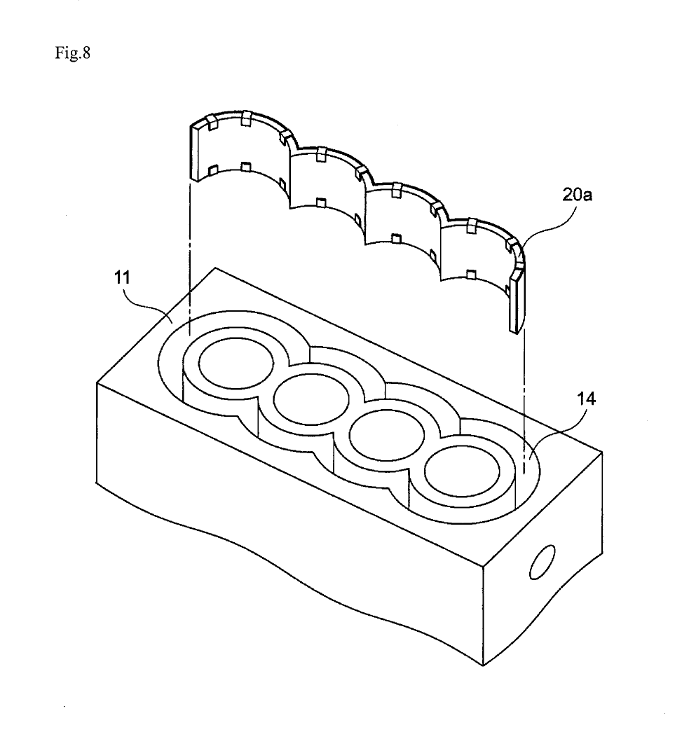

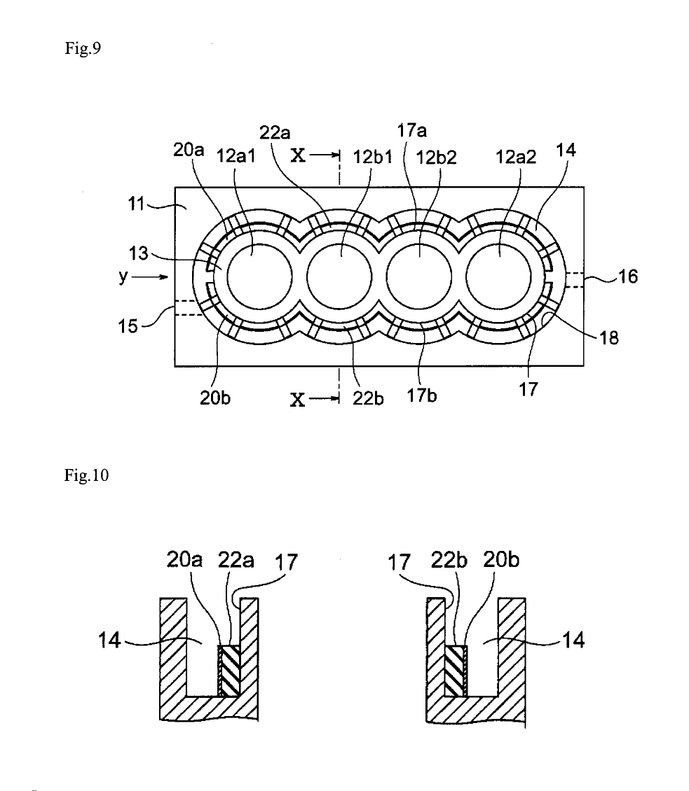

A cylinder bore wall thermal insulator according to one embodiment of the invention and an internal combustion engine according to one embodiment of the invention are described below with reference to FIGS. 1 to 10. FIGS. 1 to 3 illustrate an example of a cylinder block in which the cylinder bore wall thermal insulator according to one embodiment of the invention is disposed. FIG. 1 is a schematic plan view illustrating the cylinder block in which the cylinder bore wall thermal insulator according to one embodiment of the invention is disposed, FIG. 2 is a cross-sectional view taken along the line x-x illustrated in FIG. 1, and FIG. 3 is a perspective view illustrating the cylinder block illustrated in FIG. 1. FIGS. 4A to 7 illustrate an example of the cylinder bore wall thermal insulator according to one embodiment of the invention. FIGS. 4A and 4B are schematic perspective views illustrating an example of the cylinder bore wall thermal insulator according to one embodiment of the invention, wherein FIG. 4A is a perspective view illustrating the side where a rubber member is provided, and FIG. 4B is a perspective view illustrating the side where a metal base member is provided. FIG. 5 is a top plan view illustrating the cylinder bore wall thermal insulator illustrated in FIGS. 4A and 4B, FIG. 6 is a side view illustrating the rubber member of the cylinder bore wall thermal insulator illustrated in FIG. 4, and FIG. 7 is a side view illustrating the metal base member of the cylinder bore wall thermal insulator illustrated in FIGS. 4A and 4B. FIG. 8 is a schematic view illustrating a state in which a cylinder bore wall thermal insulator (20) is provided to (inserted into) the cylinder block (11) illustrated in FIG. 1, FIG. 9 is a schematic view illustrating a state in which two cylinder bore wall thermal insulators (20a, 20b) have been provided to (inserted into) the cylinder block (11) illustrated in FIG. 1, and FIG. 10 is an end view taken along the line x-x illustrated in FIG. 9.

As illustrated in FIGS. 1 to 3, an open-deck cylinder block 11 for an automotive internal combustion engine (in which the cylinder bore wall thermal insulator is disposed) includes a plurality of bores 12 and a groove-like coolant passage 14, a piston moving upward and downward in each bore 12, and a coolant flowing through the groove-like coolant passage 14. The boundary between the bores 12 and the groove-like coolant passage 14 is defined by a cylinder bore wall 13. The cylinder block 11 also includes a coolant inlet 15 for supplying the coolant to the groove-like coolant passage 11, and a coolant outlet 16 for discharging the coolant from the groove-like coolant passage 11.

Two or more bores 12 are formed in the cylinder block 11 so as to be arranged in series. Specifically, the bores 12 include end bores 12a1 and 12a2 that are formed to be adjacent to one bore, and intermediate bores 12b1 and 12b2 that are formed between two bores. Note that only the end bores are provided when the number of bores formed in the cylinder block is 2. The end bores 12a1 and 12a2 among the bores 12 that are arranged in series are bores situated on either end, and the intermediate bores 12b1 and 12b2 among the bores 12 that are arranged in series are bores situated between the end bore 12a1 situated on one end and the end bore 12a2 situated on the other end.

Note that the wall surface of the groove-like coolant passage 14 that is situated on the side of the cylinder bores is referred to as “cylinder bore-side wall surface 17”, and the wall surface of the groove-like coolant passage 14 that is situated opposite to the cylinder bore-side wall surface 17 is referred to as “wall surface 18”.

The cylinder bore wall thermal insulator 20 illustrated in FIGS. 4A to 7 includes a metal base member 21, a rubber member 22, and a metal leaf spring member 23.

The rubber member 22 is formed to have a shape in which four arcs are consecutively formed when viewed from above. A contact surface 25 of the rubber member 22 has a shape that conforms to the shape of the cylinder bore-side wall surface 17 of the middle-lower part of the groove-like coolant passage 14. The rubber member 22 is secured on the metal base member 21 in a state in which bendable parts 24 that are formed on the upper side and the lower side of the metal base member 21 are bent so that the rubber member 22 is held between the metal base member 21 and the bendable parts 24. The contact surface 25 of the rubber member 22 that is situated opposite to the metal base member 21 comes in contact with the cylinder bore-side wall surface 17 of the middle-lower part of the groove-like coolant passage 14.

The metal base member 21 is formed to have a shape in which four arcs are consecutively formed when viewed from above. The metal base member 21 has a shape that conforms to the shape of the back surface of the rubber member 22 (that is situated opposite to the contact surface 25).

The rubber member 22 of the cylinder bore wall thermal insulator 20 includes an end bore rubber member 35a that comes in contact with the cylinder bore-side wall surface 17 of the middle-lower part of the groove-like coolant passage 14 in an area corresponding to the end bore 12a1 that is situated on one end, an end bore rubber member 35b that comes in contact with the cylinder bore-side wall surface 17 of the middle-lower part of the groove-like coolant passage 14 in an area corresponding to the end bore 12a2 that is situated on the other end, and intermediate bore rubber members 36a and 36b that come in contact with the cylinder bore-side wall surface 17 of the middle-lower part of the groove-like coolant passage 14 in an area corresponding to the intermediate bores 12b1 and 12b2. The end bore rubber member 35a is a rubber member that insulates the wall surface that surrounds the end bore 12a1 situated on one end, the end bore rubber member 35b is a rubber member that insulates the wall surface that surrounds the end bore 12a2 situated on the other end, the intermediate bore rubber member 36a is a rubber member that insulates the wall surface that surrounds the intermediate bore 12b1, and the intermediate bore rubber member 36b is a rubber member that insulates the wall surface that surrounds the intermediate bore 12b2.

The metal base member 21 of the cylinder bore wall thermal insulator 20 is formed of one metal sheet that extends from the end bore 12a1 situated on one end to the end bore 12a2 situated on the other end. The metal base member 21 of the cylinder bore wall thermal insulator 20 includes an end bore metal base member 37a that surrounds the end bore 12a1 situated on one end, intermediate bore metal base members 38a and 38b that surround the intermediate bores 12b1 and 12b2, and an end bore metal base member 37b that surrounds the end bore 12a2 situated on the other end, the end bore metal base member 37a, the intermediate bore metal base members 38a and 38b, and the end bore metal base member 37b being connected to each other.

The metal base member 21 is provided with the metal leaf spring member 23 that is integrally formed with the metal base member 21. The metal leaf spring member 23 is a plate-shaped elastic body that is formed of a metal. The metal leaf spring member 23 is bent with respect to the metal base member 21 at an end 27 (i.e., the other end) so that an end 26 (i.e., one end) is situated away from the metal base member 21.

The cylinder bore wall thermal insulator 20 is provided to the middle-lower part of the groove-like coolant passage 14 of the cylinder block 11 illustrated in FIG. 1, for example. As illustrated in FIG. 8, the cylinder bore wall thermal insulator 20 is inserted into the groove-like coolant passage 14 of the cylinder block 11 so that the cylinder bore wall thermal insulator 20 is provided to the middle-lower part of the groove-like coolant passage 14 (see FIGS. 9 and 10). The cylinder bore wall thermal insulator 20 includes cylinder bore wall thermal insulators 20a and 20b, the cylinder bore wall thermal insulator 20a being formed so that a rubber member 22a has a shape that conforms to the shape of a wall surface 17a (i.e., half of the cylinder bore-side wall surface 17) of the middle-lower part of the groove-like coolant passage 14, and the cylinder bore wall thermal insulator 20b being formed so that a rubber member 22b has a shape that conforms to the shape of a wall surface 17b (i.e., the other half of the cylinder bore-side wall surface 17) of the middle-lower part of the groove-like coolant passage 14. Therefore, the cylinder bore wall thermal insulator 20a is provided to the wall surface 17a (i.e., half of the cylinder bore-side wall surface 17), and the cylinder bore wall thermal insulator 20b is provided to the wall surface 17b (i.e., the other half of the cylinder bore-side wall surface 17).

The metal leaf spring member 23 of the cylinder bore wall thermal insulator 20 is provided so that the distance from the contact surface 25 of the rubber member 22 to the end 26 of the metal leaf spring member 23 is greater than the width of the groove-like coolant passage 14. Therefore, when the cylinder bore wall thermal insulator 20 has been provided to the middle-lower part of the groove-like coolant passage 14, the metal leaf spring member 23 is held between the metal base member 21 (rubber member 22) and the wall surface 18, and a force that pushes the end 26 of the metal leaf spring member 23 toward the metal base member 21 is applied to the end 26 of the metal leaf spring member 23. Since the metal leaf spring member 23 is deformed so that the end 26 moves closer to the metal base member 21, the metal leaf spring member 23 produces an elastic force that causes the metal leaf spring member 23 to return to the original position. The metal base member 21 is pressed against the cylinder bore-side wall surface 17 of the groove-like coolant passage 14 due to the elastic force, and the rubber member 22 is pressed against the cylinder bore-side wall surface 17 of the groove-like coolant passage 14 due to the metal base member 21. Specifically, the metal leaf spring member 23 is deformed when the cylinder bore wall thermal insulator 20 has been provided to the middle-lower part of the groove-like coolant passage 14, and the metal base member 21 is biased due to the elastic force that occurs due to the deformation so as to press the rubber member 22 against the cylinder bore-side wall surface 17 of the groove-like coolant passage 14. Accordingly, the rubber member 22a of the cylinder bore wall thermal insulator 20a comes in contact with the wall surface 17a (i.e., half of the cylinder bore-side wall surface 17) of the middle-lower part of the groove-like coolant passage 14, and the rubber member 22b of the cylinder bore wall thermal insulator 20b comes in contact with the wall surface 17b (i.e., the other half of the cylinder bore-side wall surface 17) of the middle-lower part of the groove-like coolant passage 14.

Note that half of the cylinder bore-side wall surface of the middle-lower part of the groove-like coolant passage refers to half of the cylinder bore-side wall surface when the cylinder bore-side wall surface of the middle-lower part of the groove-like coolant passage is equally divided into two segments (in the vertical direction) along the direction in which the cylinder bores are arranged. In the example illustrated in FIG. 9, the cylinder bores are arranged in the direction that extends along the line y-y, and half of the cylinder bore-side wall surface of the middle-lower part of the groove-like coolant passage refers to half of the cylinder bore-side wall surface when the cylinder bore-side wall surface of the middle-lower part of the groove-like coolant passage is equally divided into two segments (in the vertical direction) along the direction that extends along the line y-y. In the example illustrated in FIG. 9, half of the wall surface of the middle-lower part of the groove-like coolant passage that is situated on the upper side with respect to the line y-y is the wall surface 17a (i.e., half of the cylinder bore-side wall surface 17) of the middle-lower part of the groove-like coolant passage 14, and half of the wall surface of the middle-lower part of the groove-like coolant passage that is situated on the lower side with respect to the line y-y is the wall surface 17b (i.e., the other half of the cylinder bore-side wall surface 17) of the middle-lower part of the groove-like coolant passage 14.

The cylinder bore wall thermal insulator 20 is produced using the method illustrated in FIGS. 11 to 15, for example. Note that the cylinder bore wall thermal insulator according to one embodiment of the invention may be produced using a method other than the method described below.

As illustrated in FIG. 11, clipping target parts 31 and 32 (see the dotted lines) are removed by cutting from a rectangular metal sheet 30 to obtain the metal base member 21 (that is to be formed) illustrated in FIG. 12. The metal base member 21 is provided with the bendable parts 24 that are formed on the upper side and the lower side, and the metal leaf spring members 23 (situated in the center area) are integrally formed with the metal base member 21.

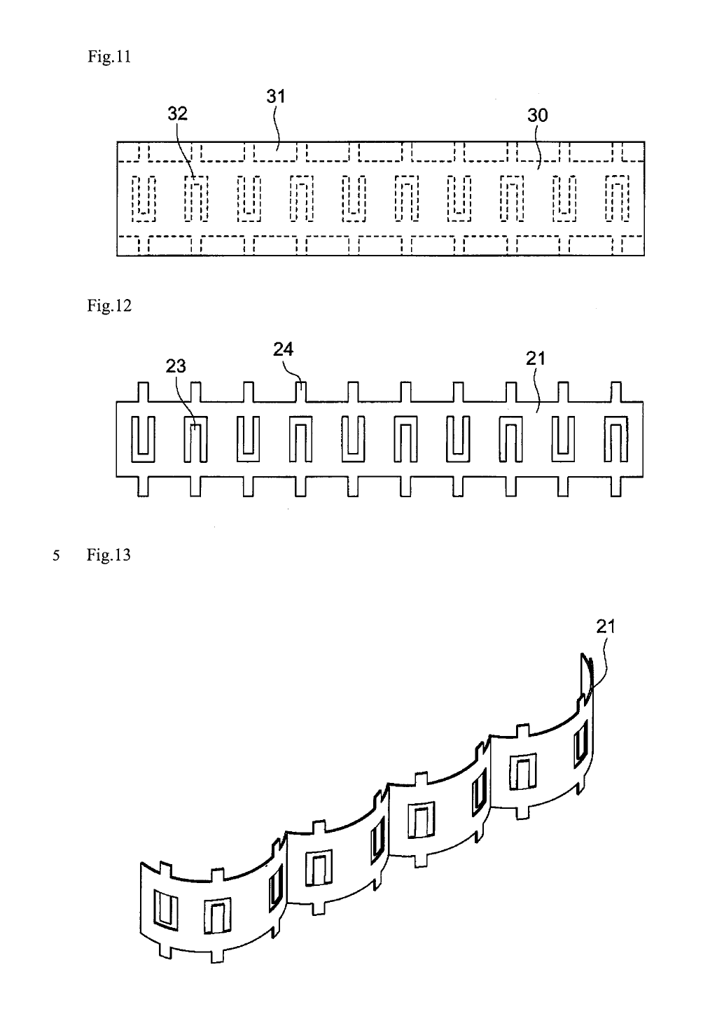

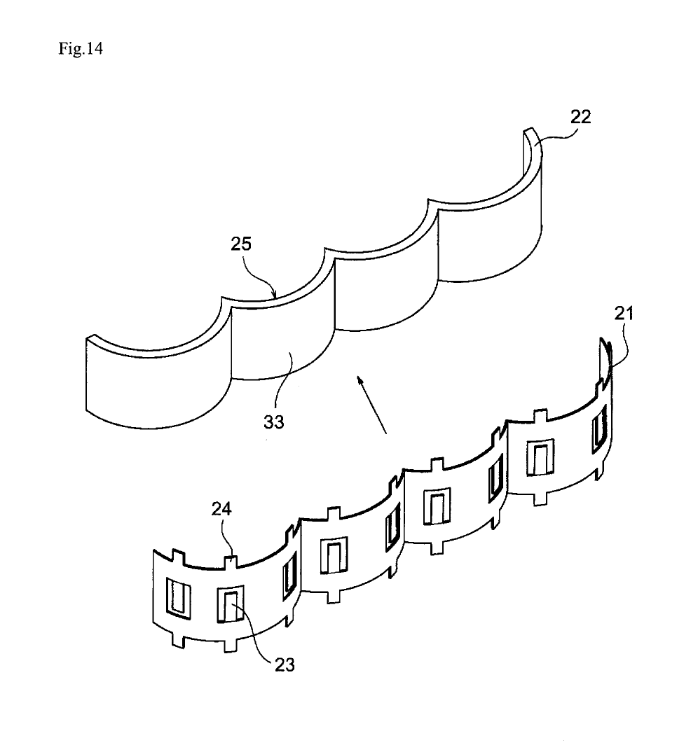

As illustrated in FIG. 13, the metal base member 21 is formed to have a shape that conforms to the shape of the back surface of the rubber member 22 (i.e., the back surface 33 of the rubber member 22 illustrated in FIG. 14).

As illustrated in FIG. 14, the metal base member 21 that has been formed is bonded to the rubber member 22 that has been formed so that the contact surface 25 has a shape that conforms to the shape of the cylinder bore-side wall surface 17 of the middle-lower part of the groove-like coolant passage 14.

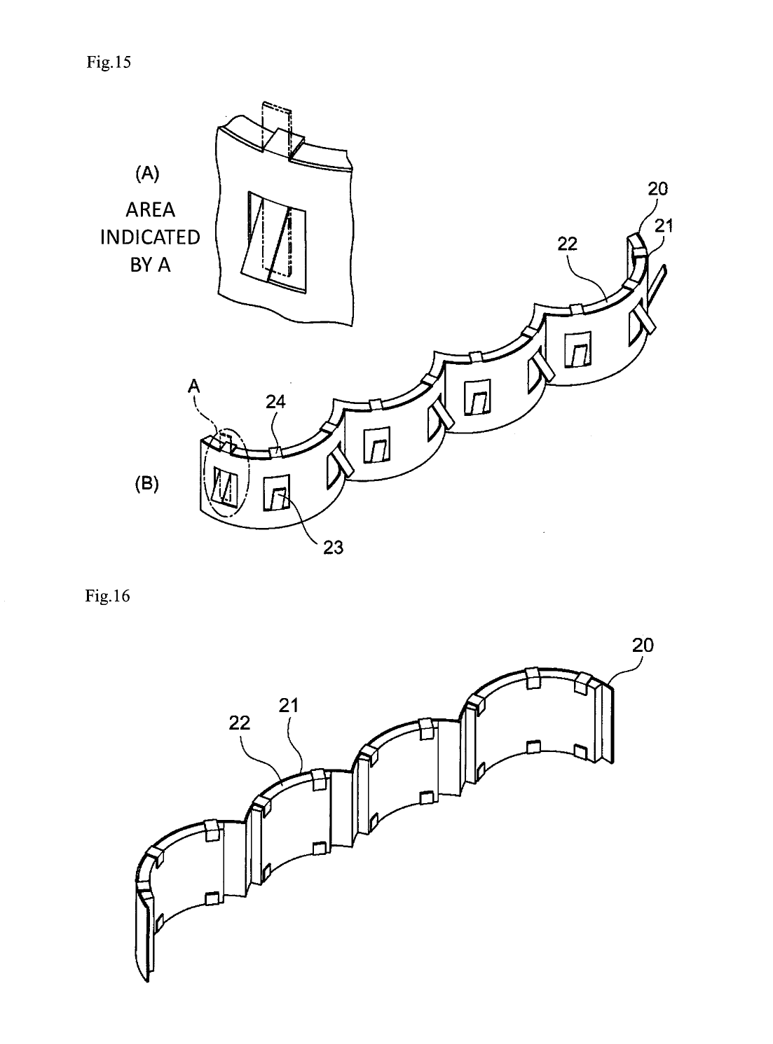

As illustrated in FIGS. 15A and 15B, the bendable parts 24 are bent so that the rubber member 22 is held between the bendable parts 24 and the metal base member 21 to secure the rubber member 22 on the metal base member 21. The metal leaf spring members 23 are also bent. In FIGS. 15A and 15B, the positions of the bendable part 24 and the metal spring member 23 that have not been bent are indicated by the dotted lines (see the part A enclosed by the two-dot chain line).

The cylinder bore wall thermal insulator according to one embodiment of the invention is provided to a middle-lower part of a groove-like coolant passage of a cylinder block included in an internal combustion engine that includes a plurality of cylinder bores, and insulates half of a cylinder bore wall, the cylinder bore wall thermal insulator including a rubber member that comes in contact with half of a cylinder bore-side wall surface of the middle-lower part of the groove-like coolant passage, and has a contact surface having a shape that conforms to the shape of the cylinder bore-side wall surface of the middle-lower part of the groove-like coolant passage, a metal base member on which the rubber member is secured, and an elastic member that is provided to the metal base member, and biases the metal base member so that the metal base member presses the rubber member against the cylinder bore-side wall surface of the middle-lower part of the groove-like coolant passage, the rubber member including an end bore rubber member that insulates part of the cylinder bore wall that surrounds an end bore that is situated on one end, and an end bore rubber member that insulates part of the cylinder bore wall that surrounds an end bore that is situated on the other end, or including an end bore rubber member that insulates part of the cylinder bore wall that surrounds an end bore that is situated on one end, an end bore rubber member that insulates part of the cylinder bore wall that surrounds an end bore that is situated on the other end, and one or more intermediate bore rubber members that respectively insulate part of the cylinder bore wall that surrounds an intermediate bore, the metal base member being integrally formed to cover a range from the part of the cylinder bore wall that surrounds the end bore that is situated on one end to the part of the cylinder bore wall that surrounds the end bore that is situated on the other end, and one or more elastic members being provided corresponding to each end bore metal base member and each intermediate bore metal base member.

Examples of the cylinder bore wall thermal insulator according to one embodiment of the invention include a cylinder bore wall thermal insulator according to a first embodiment of the invention and a cylinder bore wall thermal insulator according to a second embodiment of the invention (see below).

The cylinder bore wall thermal insulator according to the first embodiment of the invention (hereinafter may be referred to as “cylinder bore wall thermal insulator (1)”) is provided to a middle-lower part of a groove-like coolant passage of a cylinder block included in an internal combustion engine that includes three or more cylinder bores, and insulates half of a cylinder bore wall, the cylinder bore wall thermal insulator including a rubber member that comes in contact with half of a cylinder bore-side wall surface of the middle-lower part of the groove-like coolant passage, and has a contact surface having a shape that conforms to the shape of the cylinder bore-side wall surface of the middle-lower part of the groove-like coolant passage, a metal base member on which the rubber member is secured, and an elastic member that is provided to the metal base member, and biases the metal base member so that the metal base member presses the rubber member against the cylinder bore-side wall surface of the middle-lower part of the groove-like coolant passage, the rubber member including an end bore rubber member that insulates part of the cylinder bore wall that surrounds an end bore that is situated on one end, an end bore rubber member that insulates part of the cylinder bore wall that surrounds an end bore that is situated on the other end, and one or more intermediate bore rubber members that respectively insulate part of the cylinder bore wall that surrounds an intermediate bore, the metal base member being integrally formed to cover a range from the part of the cylinder bore wall that surrounds the end bore that is situated on one end to the part of the cylinder bore wall that surrounds the end bore that is situated on the other end, and one or more elastic members being provided corresponding to each end bore metal base member and each intermediate bore metal base member.

The cylinder bore wall thermal insulator according to the second embodiment of the invention (hereinafter may be referred to as “cylinder bore wall thermal insulator (2)”) is provided to a middle-lower part of a groove-like coolant passage of a cylinder block included in an internal combustion engine that includes two cylinder bores, and insulates half of a cylinder bore wall, the cylinder bore wall thermal insulator including a rubber member that comes in contact with half of a cylinder bore-side wall surface of the middle-lower part of the groove-like coolant passage, and has a contact surface having a shape that conforms to the shape of the cylinder bore-side wall surface of the middle-lower part of the groove-like coolant passage, a metal base member on which the rubber member is secured, and an elastic member that is provided to the metal base member, and biases the metal base member so that the metal base member presses the rubber member against the cylinder bore-side wall surface of the middle-lower part of the groove-like coolant passage, the rubber member including an end bore rubber member that insulates part of the cylinder bore wall that surrounds an end bore that is situated on one end, and an end bore rubber member that insulates part of the cylinder bore wall that surrounds an end bore that is situated on the other end, the metal base member being integrally formed to cover a range from the part of the cylinder bore wall that surrounds the end bore that is situated on one end to the part of the cylinder bore wall that surrounds the end bore that is situated on the other end, and one or more elastic members being provided corresponding to each end bore metal base member.

The cylinder bore wall thermal insulator (1) and the cylinder bore wall thermal insulator (2) have an identical configuration, except that the number of cylinder bores formed in the cylinder block in which the thermal insulator is provided differs between the cylinder bore wall thermal insulator (1) and the cylinder bore wall thermal insulator (2).

The cylinder bore wall thermal insulator (1) and the cylinder bore wall thermal insulator (2) are provided to the middle-lower part of the groove-like coolant passage of the cylinder block included in the internal combustion engine. The cylinder block in which the cylinder bore wall thermal insulator (1) is provided is an open-deck cylinder block in which three or more cylinder bores are formed to be arranged in series. Specifically, the cylinder block in which the cylinder bore wall thermal insulator (1) is provided includes cylinder bores including two end bores and one or more intermediate bores. The cylinder block in which the cylinder bore wall thermal insulator (2) is provided is an open-deck cylinder block in which two cylinder bores are formed to be arranged in series. Specifically, the cylinder block in which the cylinder bore wall thermal insulator (2) is provided includes cylinder bores including two end bores. Note that the term “end bore” used herein refers to a cylinder bore among a plurality of cylinder bores arranged in series that is situated on either end, and the term “intermediate bore” used herein refers to a cylinder bore among a plurality of cylinder bores arranged in series that is situated between other cylinder bores among the plurality of cylinder bores.

The cylinder bore wall thermal insulator (1) and the cylinder bore wall thermal insulator (2) are provided to the middle-lower part of the groove-like coolant passage. In FIG. 2, the dotted line indicates an intermediate position (10) between the uppermost position (uppermost side) (9) and the lowermost position (lowermost side) (8) of the groove-like coolant passage 14. The term “middle-lower part” used herein in connection with the groove-like coolant passage refers to part of the groove-like coolant passage 14 that is situated under the intermediate position 10. Note that the term “middle-lower part” used herein in connection with the groove-like coolant passage does not necessarily refer to part of the groove-like coolant passage that is situated under the middle position between the uppermost position and the lowermost position, but also refers to part of the groove-like coolant passage that is situated under an approximately middle position between the uppermost position and the lowermost position. Specifically, part (i.e., middle-lower part) of the groove-like coolant passage that is insulated using the cylinder bore wall thermal insulator (i.e., the position of the upper end of the rubber member with respect to the groove-like coolant passage in the upward-downward direction) is appropriately selected.

The rubber member comes in contact with the cylinder bore-side wall surface of the middle-lower part of the groove-like coolant passage to insulate the middle-lower part of the cylinder bore wall. Therefore, the contact surface of the rubber member (that comes in contact with the cylinder bore-side wall surface of the middle-lower part of the groove-like coolant passage) is formed to have a shape that conforms to the shape of the cylinder bore-side wall surface of the middle-lower part of the groove-like coolant passage. When the cylinder bore wall thermal insulator (1) or the cylinder bore wall thermal insulator (2) is provided to the middle-lower part of the groove-like coolant passage, the metal base member is pushed through the elastic member, and the contact surface (that is situated opposite to the metal base member) of the rubber member comes in contact with (is pressed against) the cylinder bore-side wall surface of the middle-lower part of the groove-like coolant passage.

Examples of a material for forming the rubber member include a rubber such as a solid rubber, an expanded rubber, a foamed rubber, and a soft rubber, a silicone-based gel-like material, and the like. It is preferable to use a heat-expandable rubber or a water-swellable rubber as the material for forming the rubber member so that the rubber member expands after the cylinder bore wall thermal insulator has been provided to the groove-like coolant passage. When a heat-expandable rubber or a water-swellable rubber is used as the material for forming the rubber member, it is possible to prevent a situation in which the rubber member comes in strong contact with the cylinder bore wall (i.e., the rubber member is shaved) when the cylinder bore wall thermal insulator is provided to (inserted into) the groove-like coolant passage.

Examples of the solid rubber include a rubber such as a natural rubber, a butadiene rubber, an ethylene-propylene-diene rubber (EPDM), a nitrile-butadiene rubber (NBR), a silicone rubber, a fluororubber, and the like.

Examples of the expandable rubber include a heat-expandable rubber. The term “heat-expandable rubber” used herein refers to a composite obtained by impregnating a base foam material with a thermoplastic substance having a melting point lower than that of the base foam material, and compressing the resulting product. The heat-expandable rubber is characterized in that the compressed state is maintained at room temperature by the cured product of the thermoplastic substance that is present at least in the surface area, and the cured product of the thermoplastic substance softens due to heating so that the compressed state is canceled. Examples of the heat-expandable rubber include the heat-expandable rubber disclosed in JP-A-2004-143262. When the heat-expandable rubber is used as the material for forming the rubber member, the heat-expandable rubber expands (is deformed) to have a specific shape when the cylinder bore wall thermal insulator according to one embodiment of the invention has been provided to the middle-lower part of the groove-like coolant passage, and heat has been applied to the heat-expandable rubber.

Examples of the base foam material used to produce the heat-expandable rubber include a polymer material such as a rubber, an elastomer, a thermoplastic resin, and a thermosetting resin. Specific examples of the base foam material include a natural rubber, a synthetic rubber such as a chloropropylene rubber, a styrene-butadiene rubber, a nitrile-butadiene rubber, an ethylene-propylene-diene terpolymer, a silicone rubber, a fluororubber, and an acrylic rubber, an elastomer such as soft urethane, and a thermosetting resin such as rigid urethane, a phenolic resin, and a melamine resin.

It is preferable to use a thermoplastic substance having a glass transition temperature, a melting point, or a softening temperature of less than 120° C. as the thermoplastic substance used to produce the heat-expandable rubber. Examples of the thermoplastic substance used to produce the heat-expandable rubber include a thermoplastic resin such as polyethylene, polypropylene, polystyrene, polyvinyl chloride, polyvinylidene chloride, polyvinyl acetate, a polyacrylate, a styrene-butadiene copolymer, chlorinated polyethylene, polyvinylidene fluoride, an ethylene-vinyl acetate copolymer, an ethylene-vinyl acetate-vinyl chloride-acrylate copolymer, an ethylene-vinyl acetate-acrylate copolymer, an ethylene-vinyl acetate-vinyl chloride copolymer, nylon, an acrylonitrile-butadiene copolymer, polyacrylonitrile, polyvinyl chloride, polychloroprene, polybutadiene, a thermoplastic polyimide, a polyacetal, polyphenylene sulfide, a polycarbonate, and a thermoplastic polyurethane, and a thermoplastic compound such as a low-melting-point glass frit, starch, a solder, and a wax.

The water-swellable rubber may also be used as the expandable rubber. The term “water-swellable rubber” used herein refers to a material obtained by adding a water-absorbing substance to a rubber. The water-swellable rubber is a rubber material that swells by absorbing water, and retains the swollen shape (i.e., has a shape retention capability). Examples of the water-swellable rubber include a rubber material obtained by adding a water-absorbing substance such as a cross-linked neutralized polyacrylic acid, a cross-linked starch-acrylic acid graft copolymer, a cross-linked carboxymethyl cellulose salt, or polyvinyl alcohol, to a rubber. Specific examples of the water-swellable rubber include the water-swellable rubber disclosed in JP-A-9-208752 that includes a ketiminated polyamide resin, a glycidyl ether, a water-absorbing resin, and a rubber. When the water-swellable rubber is used as the material for forming the rubber member, the water-swellable rubber expands (is deformed) to have a specific shape when the cylinder bore wall thermal insulator according to one embodiment of the invention has been provided to the middle-lower part of the groove-like coolant passage, and the water-swellable rubber has absorbed water.

The foamed rubber is a porous rubber. Examples of the foamed rubber include a sponge-like foamed rubber having a continuous cell structure, a foamed rubber having a closed cell structure, a foamed rubber having a semi-closed cell structure, and the like. Examples of a material for producing the foamed rubber include an ethylene-propylene-diene terpolymer, a silicone rubber, a nitrile-butadiene copolymer, a silicone rubber, a fluororubber, and the like. The expansion ratio of the foamed rubber is appropriately selected. The water content in the rubber member can be adjusted by adjusting the expansion ratio. Note that the expansion ratio of the foamed rubber refers to the density ratio calculated by “((density before foaming−density after foaming)/density before foaming)×100”.

When a material that can absorb water (e.g., water-swellable rubber and foamed rubber) is used as the material for forming the rubber member, the rubber member absorbs water when the cylinder bore wall thermal insulator according to one embodiment of the invention has been provided in the groove-like coolant passage, and the coolant is passed through the groove-like coolant passage. The water content in the rubber member achieved when the coolant is passed through the groove-like coolant passage is appropriately selected taking account of the internal combustion engine operating conditions and the like. Note that the water content refers to the water content based on weight calculated by “(weight of coolant/(weight of filler+weight of coolant))×100”.

The thickness of the rubber member is not particularly limited, and is appropriately selected.

The metal base member is a member on which the rubber member is secured. The metal base member is a member that is pushed by the elastic force produced by the deformation of the elastic member to uniformly press the rubber member against the cylinder bore-side wall surface of the middle-lower part of the groove-like coolant passage. Therefore, the metal base member has a shape that conforms to the shape of the back surface of the rubber member (that is situated opposite to the contact surface).

A material for forming the metal base member is not particularly limited. It is preferable to use stainless steel (SUS), an aluminum alloy, and the like due to good long-life coolant resistance (LLC resistance) and high strength. The thickness of the metal base member is not particularly limited, and is appropriately selected.

In the cylinder bore wall thermal insulator 20 illustrated in FIGS. 4A and 4B, the rubber member is secured on the metal base member in a state in which the bendable parts that are formed on the upper side and the lower side of the metal base member are bent so that the rubber member is held between the metal base member and the bendable parts. Note that the rubber member may be secured on the metal base member in an arbitrary way. For example, the rubber member may be fused with the metal base member by heating, or bonded to the metal base member using an adhesive, or may be secured on the metal base member by fitting a protrusion provided to the metal base member into the rubber member.

In the cylinder bore wall thermal insulator (1), the rubber member includes the end bore rubber member that insulates part of the cylinder bore wall that surrounds the end bore that is situated on one end, the end bore rubber member that insulates part of the cylinder bore wall that surrounds the end bore that is situated on the other end, and one or more intermediate bore rubber members that respectively insulate the cylinder bore wall that surrounds the intermediate bore. Half of the cylinder bore-side wall surface of the middle-lower part of the groove-like coolant passage of the cylinder block to which the cylinder bore wall thermal insulator (1) is provided, includes the wall surface that surrounds the end bore that is situated on one end, the wall surface that surrounds the end bore that is situated on the other end, and one or more wall surfaces that respectively surround the intermediate bore. In the cylinder bore wall thermal insulator (1), the rubber member includes an area that comes in contact with the wall surface that surrounds the end bore that is situated on one end, an area that comes in contact with the wall surface that surrounds the end bore that is situated on the other end, and an area that comes in contact with one or more wall surfaces that surround the intermediate bore.

In the cylinder bore wall thermal insulator (2), the rubber member includes the end bore rubber member that insulates part of the cylinder bore wall that surrounds the end bore that is situated on one end, and the end bore rubber member that insulates part of the cylinder bore wall that surrounds the end bore that is situated on the other end. Half of the cylinder bore-side wall surface of the middle-lower part of the groove-like coolant passage of the cylinder block to which the cylinder bore wall thermal insulator (2) is provided, includes the wall surface that surrounds the end bore that is situated on one end, and the wall surface that surrounds the end bore that is situated on the other end. In the cylinder bore wall thermal insulator (2), the rubber member includes an area that comes in contact with the wall surface that surrounds the end bore that is situated on one end, and an area that comes in contact with the wall surface that surrounds the end bore that is situated on the other end.

In the example illustrated in FIGS. 4A and 4B, the end bore rubber member that insulates part of the cylinder bore wall that surrounds the end bore that is situated on one end, one or more intermediate bore rubber members that respectively insulate the cylinder bore wall that surrounds the intermediate bore, and the end bore rubber member that insulates part of the cylinder bore wall that surrounds the end bore that is situated on the other end, are formed continuously. Note that the invention is not limited thereto. For example, the cylinder bore wall thermal insulator (1) may have a configuration illustrated in FIG. 16 in which the rubber member is divided corresponding to each bore wall. The cylinder bore wall thermal insulator (1) may have a configuration in which the rubber member provided corresponding to each bore wall (see FIG. 16) is further divided into a plurality of segments. Specifically, the cylinder bore wall thermal insulator (1) may have a configuration in which the end bore rubber member that insulates part of the cylinder bore wall that surrounds the end bore that is situated on one end, one or more intermediate bore rubber members that respectively insulate the cylinder bore wall that surrounds the intermediate bore, and the end bore rubber member that insulates part of the cylinder bore wall that surrounds the end bore that is situated on the other end, are formed continuously, or may have a configuration in which the end bore rubber member that insulates part of the cylinder bore wall that surrounds the end bore that is situated on one end, one or more intermediate bore rubber members that respectively insulate the cylinder bore wall that surrounds the intermediate bore, and the end bore rubber member that insulates part of the cylinder bore wall that surrounds the end bore that is situated on the other end, are formed discontinuously. It is preferable that the cylinder bore wall thermal insulator (1) have a configuration in which the end bore rubber member that insulates part of the cylinder bore wall that surrounds the end bore that is situated on one end, one or more intermediate bore rubber members that respectively insulate the cylinder bore wall that surrounds the intermediate bore, and the end bore rubber member that insulates part of the cylinder bore wall that surrounds the end bore that is situated on the other end, are formed continuously, since the cylinder bore wall thermal insulator is rarely displaced in the groove-like coolant passage due to vibrations or the flow of the coolant. The cylinder bore wall thermal insulator (2) may have a configuration in which the end bore rubber member that insulates part of the cylinder bore wall that surrounds the end bore that is situated on one end, and the end bore rubber member that insulates part of the cylinder bore wall that surrounds the end bore that is situated on the other end, are formed continuously, or may have a configuration in which the end bore rubber member that insulates part of the cylinder bore wall that surrounds the end bore that is situated on one end, and the end bore rubber member that insulates part of the cylinder bore wall that surrounds the end bore that is situated on the other end, are formed discontinuously. It is preferable that the cylinder bore wall thermal insulator (2) have a configuration in which the end bore rubber member that insulates part of the cylinder bore wall that surrounds the end bore that is situated on one end, and the end bore rubber member that insulates part of the cylinder bore wall that surrounds the end bore that is situated on the other end, are formed continuously, since the cylinder bore wall thermal insulator is rarely displaced in the groove-like coolant passage due to vibrations or the flow of the coolant.

In the cylinder bore wall thermal insulator (1) and the cylinder bore wall thermal insulator (2), the rubber member may cover the entirety of half of the cylinder bore-side wall surface of the middle-lower part of the groove-like coolant passage, or may cover part of half of the cylinder bore-side wall surface of the middle-lower part of the groove-like coolant passage so that only the areas required to insulate the middle-lower part of the cylinder bore wall are covered with the rubber member.

In the cylinder bore wall thermal insulator (1), the metal base member is integrally formed to cover a range from the part of the cylinder bore wall that surrounds the end bore that is situated on one end to the part of the cylinder bore wall that surrounds the end bore that is situated on the other end. Specifically, the cylinder bore wall thermal insulator (1) has a configuration in which the metal base member is formed so that the end bore metal base member that surrounds the end bore situated on one end, one or more intermediate bore metal base members that respectively surround the intermediate bore, and the end bore metal base member that surrounds the end bore situated on the other end, are formed integrally. In the example illustrated in FIGS. 4A and 4B, the metal base member has a configuration in which the end bore metal base member that surrounds the end bore situated on one end, one or more intermediate bore metal base members that respectively surround the intermediate bore, and the end bore metal base member that surrounds the end bore situated on the other end, are formed by a single metal sheet. Note that the invention is not limited thereto. The metal base member may have a configuration in which the end bore metal base member that surrounds the end bore situated on one end, one or more intermediate bore metal base members that respectively surround the intermediate bore, and the end bore metal base member that surrounds the end bore situated on the other end, are formed by a single metal sheet, or may have a configuration in which the end bore metal base member that surrounds the end bore situated on one end, one or more intermediate bore metal base members that respectively surround the intermediate bore, and the end bore metal base member that surrounds the end bore situated on the other end, are formed by bonding a plurality of metal sheets, as long as the end bore metal base member that surrounds the end bore situated on one end, one or more intermediate bore metal base members that respectively surround the intermediate bore, and the end bore metal base member that surrounds the end bore situated on the other end, are connected to each other (i.e., formed integrally). In the cylinder bore wall thermal insulator (2), the metal base member is integrally formed to cover a range from the part of the cylinder bore wall that surrounds the end bore that is situated on one end to the part of the cylinder bore wall that surrounds the end bore that is situated on the other end. Specifically, the cylinder bore wall thermal insulator (2) has a configuration in which the metal base member is formed so that the end bore metal base member that surrounds the end bore situated on one end, and the end bore metal base member that surrounds the end bore situated on the other end, are formed integrally. The metal base member may have a configuration in which the end bore metal base member that surrounds the end bore situated on one end, and the end bore metal base member that surrounds the end bore situated on the other end, are formed by a single metal sheet, or may have a configuration in which the end bore metal base member that surrounds the end bore situated on one end, and the end bore metal base member that surrounds the end bore situated on the other end, are formed by bonding a plurality of metal sheets, as long as the end bore metal base member that surrounds the end bore situated on one end, and the end bore metal base member that surrounds the end bore situated on the other end, are connected to each other (i.e., formed integrally).

The elastic member is provided to the metal base member. The elastic member is elastically deformed when the cylinder bore wall thermal insulator according to one embodiment of the invention has been provided to the middle-lower part of the groove-like coolant passage, and biases the metal base member so as to press the rubber member against the cylinder bore-side wall surface of the middle-lower part of the groove-like coolant passage.

In the cylinder bore wall thermal insulator (1), one or more elastic members are provided corresponding to each of the end bore metal base member and the intermediate bore metal base member. Specifically, the elastic member is provided to each of the end bore metal base member and the intermediate bore metal base member at at least one position in the arc direction when the cylinder bore wall thermal insulator according to one embodiment of the invention is viewed from above. It is preferable that the elastic member be provided to each of the end bore metal base member and the intermediate bore metal base member at two or more positions (more preferably three or more positions) in the arc direction when the cylinder bore wall thermal insulator according to one embodiment of the invention is viewed from above. In the cylinder bore wall thermal insulator 20 illustrated in FIGS. 4A and 4B, the elastic member is provided to the end bore metal base member at three positions in the arc direction, and is provided to the intermediate bore metal base member at two positions in the arc direction.

In the cylinder bore wall thermal insulator (2), one or more elastic members are provided corresponding to each end bore metal base member. Specifically, the elastic member is provided to each of the end bore metal base member that surrounds the end bore that is situated on one end, and the end bore metal base member that surrounds the end bore that is situated on the other end, at at least one position in the arc direction, when the cylinder bore wall thermal insulator according to one embodiment of the invention is viewed from above. It is preferable that the elastic member be provided to each end bore metal base member at two or more positions (more preferably three or more positions) in the arc direction when the cylinder bore wall thermal insulator according to one embodiment of the invention is viewed from above.

The configuration of the elastic member is not particularly limited. The elastic member may be a plate-like elastic member, a coil-like elastic member, a leaf spring, a torsion spring, an elastic rubber, or the like. A material for forming the elastic member is not particularly limited. It is preferable to use stainless steel (SUS), an aluminum alloy, and the like due to LLC resistance and high strength. It is preferable to use a metal elastic member (e.g., metal leaf spring, coil spring, leaf spring, or torsion spring) as the elastic member.

The configuration, the shape, the size, the position, the number, and the like of the elastic member(s) are appropriately selected taking account of the shape of the groove-like coolant passage and the like so that the rubber member is biased by the elastic member with an appropriate force when the cylinder bore wall thermal insulator according to one embodiment of the invention has been provided to the middle-lower part of the groove-like coolant passage.

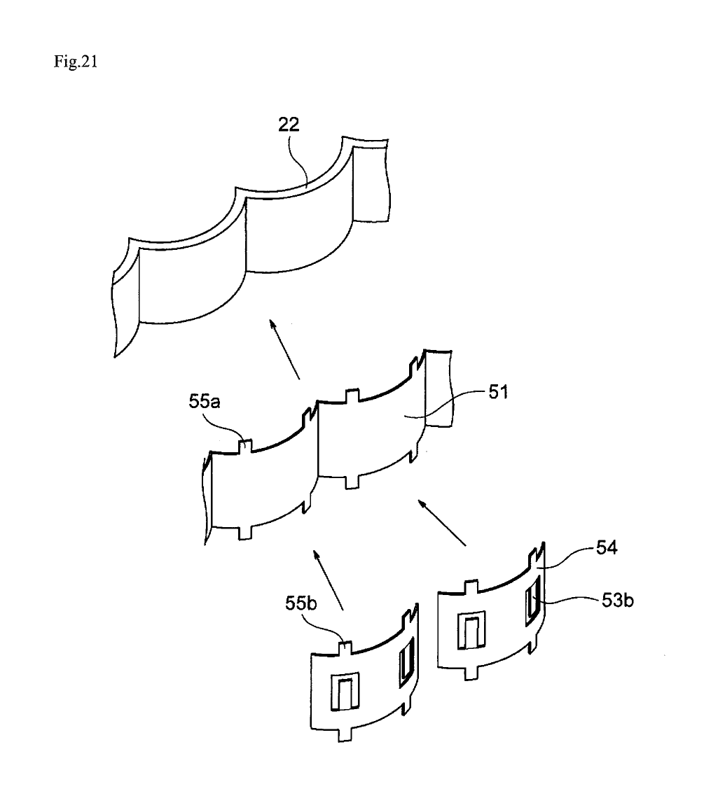

In the cylinder bore wall thermal insulator 20 illustrated in FIGS. 4A and 4B, the elastic member is integrally formed with the metal base member. Note that the elastic member may be provided to the metal base member in an arbitrary way. For example, a metal elastic member (e.g., metal leaf spring, metal coil spring, leaf spring, or torsion spring) may be welded to the metal base member. In the example illustrated in FIG. 20, a metal leaf spring 53a formed by a rectangular metal sheet is provided by welding to a metal base member 51 (that is not provided with the clipping target part). As illustrated in FIG. 21, the elastic member may be provided to the metal base member by providing the metal base member 51 (that is not provided with the clipping target part), and a metal leaf spring member 54 for providing a metal leaf spring in which the clipping target parts have been removed so that metal leaf springs 53b are formed, stacking the metal base member 51 and the metal leaf spring member 54 on the rubber member 22, and bending bendable parts 55a and 55b to secure the metal base member 51 on the rubber member 22, and secure the metal leaf springs 53b (i.e., elastic members) on the rubber member 22 through the metal base member 51.

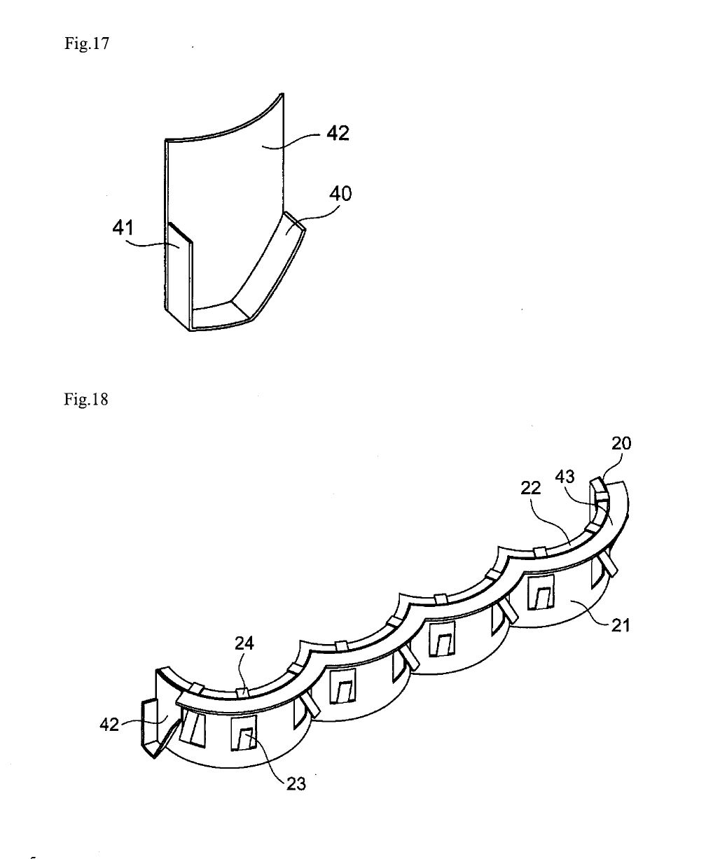

The cylinder bore wall thermal insulator (1) and the cylinder bore wall thermal insulator (2) may include a coolant flow adjustment member that is provided at a position near the coolant inlet of the cylinder block, and adjusts the flow of the coolant so that the coolant supplied from outside flows into the upper part of the groove-like coolant passage. For example, the coolant flow adjustment member may have the configuration illustrated in FIG. 17. FIG. 17 is a schematic perspective view illustrating an example of the coolant flow adjustment member. As illustrated in FIG. 17, a coolant flow adjustment member 42 includes a damming section 41 that dams the flow of the coolant toward the middle-lower part of the groove-like coolant passage, and a slope section 40 that causes the coolant supplied from outside to flow from the middle-lower part of the groove-like coolant passage to the upper part of the groove-like coolant passage. The coolant flow adjustment member 42 is provided to the cylinder bore wall thermal insulator (1) and the cylinder bore wall thermal insulator (2) at a position near the coolant inlet. The coolant flow adjustment member 42 is configured so that the damming section 41 suppresses the flow of the coolant through the middle-lower part of the groove-like coolant passage, and the slope section 40 causes the coolant supplied from outside to flow toward the upper part of the groove-like coolant passage. It is preferable that the cylinder bore wall thermal insulator (1) or the cylinder bore wall thermal insulator (2) include the coolant flow adjustment member since it is possible to improve the cooling efficiency with respect to the upper part of the cylinder bore wall, and effectively prevent a situation in which a piston vibrates due to expansion of the upper part of the cylinder bore wall, while insulating the middle-lower part of the cylinder bore wall.

When the cylinder bore wall thermal insulator (1) or the cylinder bore wall thermal insulator (2) includes the coolant flow adjustment member that is provided to adjust the flow of the coolant so that the coolant supplied from outside flows into the upper part of the groove-like coolant passage, the cylinder bore wall thermal insulator (1) or the cylinder bore wall thermal insulator (2) may further include a horizontal rib that is provided to the upper part of the cylinder bore wall thermal insulator (1) or the cylinder bore wall thermal insulator (2) so as to extend in the direction in which the coolant flows, and suppresses a situation in which the coolant that flows through the upper part of the groove-like coolant passage flows into the middle-lower part of the groove-like coolant passage. FIG. 18 illustrates an example in which the cylinder bore wall thermal insulator includes the horizontal rib. As illustrated in FIG. 18, the cylinder bore wall thermal insulator 20 includes a horizontal rib 43 that is provided to the upper part of the metal base member 21 on the side opposite to the side where the rubber member 22 is secured, and extends in the direction in which the coolant flows approximately over the entire metal base member 21. In the example illustrated in FIG. 18, since the horizontal rib 43 is provided at the boundary between the upper part and the middle-lower part of the groove-like coolant passage, it is possible to suppress a situation in which the coolant that flows through the upper part of the groove-like coolant passage flows into the middle-lower part of the groove-like coolant passage.

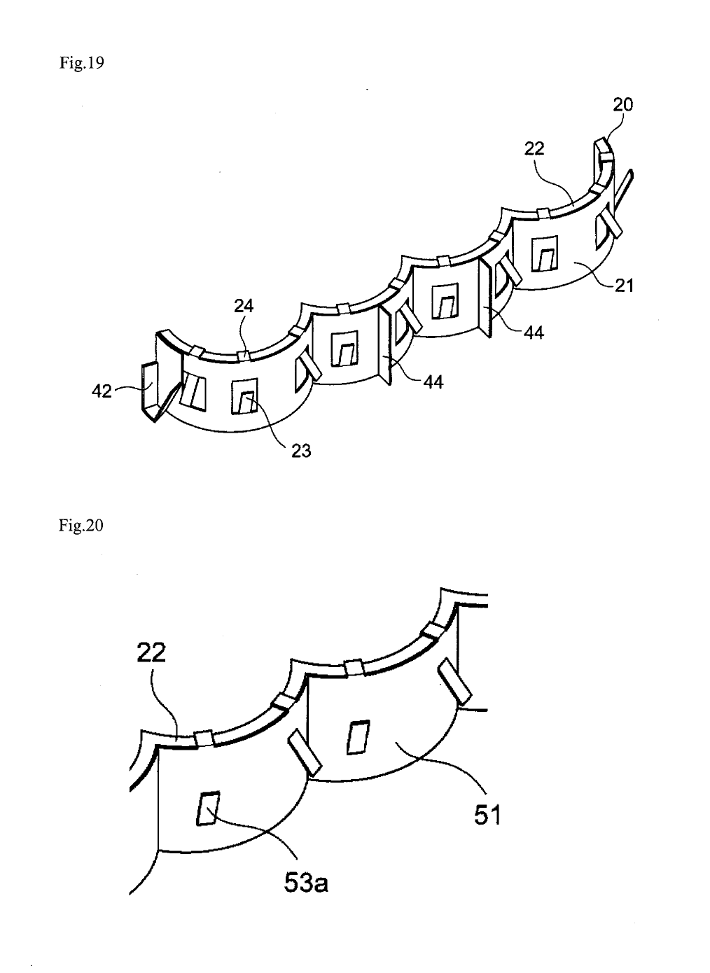

When the cylinder bore wall thermal insulator (1) or the cylinder bore wall thermal insulator (2) includes the coolant flow adjustment member that is provided to adjust the flow of the coolant so that the coolant supplied from outside flows into the upper part of the groove-like coolant passage, the cylinder bore wall thermal insulator (1) or the cylinder bore wall thermal insulator (2) may further include a vertical rib that is provided to extend in the upward-downward direction, and suppresses the flow of the coolant that flows through the middle-lower part of the groove-like coolant passage. FIG. 19 illustrates an example in which the cylinder bore wall thermal insulator includes the vertical rib. As illustrated in FIG. 19, the cylinder bore wall thermal insulator 20 includes a vertical rib 44 that is provided to the metal base member 21 on the side opposite to the side where the rubber member 22 is secured, and extends in the upward-downward direction. In the example illustrated in FIG. 19, the vertical rib 44 suppresses the flow of the coolant that flows through the middle-lower part of the groove-like coolant passage. The number of vertical ribs provided to the cylinder bore wall thermal insulator is appropriately selected.

An internal combustion engine according to one embodiment of the invention (hereinafter may be referred to as “internal combustion engine (1)”) includes the cylinder bore wall thermal insulator (1) or the cylinder bore wall thermal insulator (2) that is provided to each of half of a cylinder bore-side wall surface of a middle-lower part of a groove-like coolant passage, and the other half of the cylinder bore-side wall surface of the middle-lower part of the groove-like coolant passage. The internal combustion engine (1) has a configuration in which the entirety of the middle-lower part of the cylinder bore wall is insulated using the cylinder bore wall thermal insulator.

An internal combustion engine according to another embodiment of the invention (hereinafter may be referred to as “internal combustion engine (2)”) includes the cylinder bore wall thermal insulator (1) or the cylinder bore wall thermal insulator (2) that is provided to only half of a cylinder bore-side wall surface of a middle-lower part of a groove-like coolant passage. The internal combustion engine (2) has a configuration in which only half of the cylinder bore-side wall surface of the middle-lower part of a groove-like coolant passage is insulated using the cylinder bore wall thermal insulator, by providing the cylinder bore wall thermal insulator to only half of the middle-lower part of the groove-like coolant passage without providing the cylinder bore wall thermal insulator to the other half of the middle-lower part of the groove-like coolant passage.

An automobile according to one embodiment of the invention includes the internal combustion engine (1) or the internal combustion engine (2).

For example, the entirety of the cylinder bore-side wall surface of the middle-lower part of the groove-like coolant passage may be insulated using one thermal insulator that is formed to surround the entirety of the cylinder bore-side wall surface of the middle-lower part of the groove-like coolant passage. In this case, however, when the thermal insulator is pressed against a specific area of the cylinder bore-side wall surface of the middle-lower part of the groove-like coolant passage, the thermal insulator is removed from the opposite area of the cylinder bore-side wall surface of the middle-lower part of the groove-like coolant passage since the thermal insulator is integrally formed to surround the entirety of the cylinder bore-side wall surface of the middle-lower part of the groove-like coolant passage.

On the other hand, the cylinder bore wall thermal insulator (1) or the cylinder bore wall thermal insulator (2) is provided to half of the cylinder bore-side wall surface of the middle-lower part of the groove-like coolant passage, and is separated from the cylinder bore wall thermal insulator (1) or the cylinder bore wall thermal insulator (2) that is provided to insulate the other half of the cylinder bore-side wall surface of the middle-lower part of the groove-like coolant passage. Therefore, when the cylinder bore wall thermal insulator (1) or the cylinder bore wall thermal insulator (2) is pressed against half of the cylinder bore-side wall surface of the middle-lower part of the groove-like coolant passage, a force that removes the cylinder bore wall thermal insulator (1) or the cylinder bore wall thermal insulator (2) that is provided to insulate the other half of the cylinder bore-side wall surface of the middle-lower part of the groove-like coolant passage, does not occur. Specifically, since the cylinder bore wall thermal insulator (1) or the cylinder bore wall thermal insulator (2) can be strongly pressed against the cylinder bore-side wall surface of the middle-lower part of the groove-like coolant passage, the cylinder bore wall thermal insulator (1) or the cylinder bore wall thermal insulator (2) is rarely displaced in the groove-like coolant passage due to vibrations or the flow of the coolant. Moreover, since the cylinder bore wall thermal insulator (1) or the cylinder bore wall thermal insulator (2) has a configuration in which the metal base member is integrally formed (i.e., is not divided corresponding to each bore), the cylinder bore wall thermal insulator (1) or the cylinder bore wall thermal insulator (2) is rarely displaced in the groove-like coolant passage due to vibrations or the flow of the coolant. Since the cylinder bore wall thermal insulator (1) or the cylinder bore wall thermal insulator (2) has a configuration in which one or more elastic members are provided corresponding to each of the end bore metal base member and the intermediate bore metal base member, the rubber member is uniformly pressed against the entirety of half of the cylinder bore-side wall surface of the middle-lower part of the groove-like coolant passage. Since the cylinder bore wall thermal insulator according to one embodiment of the invention insulates the middle-lower part of the cylinder bore wall, the uniformity of the temperature of the cylinder bore wall is improved.

### INDUSTRIAL APPLICABILITY

According to the embodiments of the invention, since the difference in the amount of deformation between the upper part and the middle-lower part of the cylinder bore wall of an internal combustion engine can be reduced (i.e., friction with respect to a piston can be reduced), it is possible to provide a fuel-efficient internal combustion engine.

### REFERENCE SIGNS LIST

8 Lowermost position
9 Uppermost position
10 Middle position (approximately middle position)
11 Cylinder block
12 Bore
12a1, 12a2 End bore
12b1, 12b2 Intermediate bore
13 Cylinder bore wall
14 Groove-like coolant passage
15 Coolant inlet
16 Coolant outlet
17 Wall surface of cylinder bore wall (13) that defines groove-like coolant passage (14)
17a, 17b Half of wall surface
18 Wall surface of groove-like coolant passage (14) opposite to cylinder bore wall (13)
20 Cylinder bore wall thermal insulator
21 Metal base member
22 Rubber member
23 Metal leaf spring member
24 Bendable part
25 Contact surface
26 One end
27 Other end
30 Metal sheet
31, 32 Clipping target part
33 Back surface
35 End bore rubber member
36 Intermediate bore rubber member
37 End bore metal base member
38 Intermediate bore metal base member
40 Slope section
41 Damming section
42 Coolant flow adjustment member
43 Horizontal rib
44 Vertical rib

1. A cylinder bore wall thermal insulator that is provided to a middle-lower part of a groove-like coolant passage of a cylinder block included in an internal combustion engine that includes a plurality of cylinder bores, and insulates half of a cylinder bore wall, the cylinder bore wall thermal insulator comprising:
a rubber member that comes in contact with half of a cylinder bore-side wall surface of the middle-lower part of the groove-like coolant passage, and has a contact surface having a shape that conforms to a shape of the cylinder bore-side wall surface of the middle-lower part of the groove-like coolant passage, a metal base member on which the rubber member is secured, and an elastic member that is provided to the metal base member, and biases the metal base member so that the metal base member presses the rubber member against the cylinder bore-side wall surface of the middle-lower part of the groove-like coolant passage,
the rubber member comprising an end bore rubber member that insulates part of the cylinder bore wall that surrounds an end bore that is situated on one end, and an end bore rubber member that insulates part of the cylinder bore wall that surrounds an end bore that is situated on the other end, or comprising an end bore rubber member that insulates part of the cylinder bore wall that surrounds an end bore that is situated on one end, an end bore rubber member that insulates part of the cylinder bore wall that surrounds an end bore that is situated on the other end, and one or more intermediate bore rubber members that respectively insulate part of the cylinder bore wall that surrounds an intermediate bore,
the metal base member being integrally formed to cover a range from the part of the cylinder bore wall that surrounds the end bore that is situated on one end to the part of the cylinder bore wall that surrounds the end bore that is situated on the other end, and
one or more elastic members being provided corresponding to each end bore metal base member and each intermediate bore metal base member.

2. A cylinder bore wall thermal insulator that is provided to a middle-lower part of a groove-like coolant passage of a cylinder block included in an internal combustion engine that includes three or more cylinder bores, and insulates half of a cylinder bore wall, the cylinder bore wall thermal insulator comprising:
a rubber member that comes in contact with half of a cylinder bore-side wall surface of the middle-lower part of the groove-like coolant passage, and has a contact surface having a shape that conforms to a shape of the cylinder bore-side wall surface of the middle-lower part of the groove-like coolant passage, a metal base member on which the rubber member is secured, and an elastic member that is provided to the metal base member, and biases the metal base member so that the metal base member presses the rubber member against the cylinder bore-side wall surface of the middle-lower part of the groove-like coolant passage,
the rubber member comprising an end bore rubber member that insulates part of the cylinder bore wall that surrounds an end bore that is situated on one end, an end bore rubber member that insulates part of the cylinder bore wall that surrounds an end bore that is situated on the other end, and one or more intermediate bore rubber members that respectively insulate part of the cylinder bore wall that surrounds an intermediate bore,
the metal base member being integrally formed to cover a range from the part of the cylinder bore wall that surrounds the end bore that is situated on one end to the part of the cylinder bore wall that surrounds the end bore that is situated on the other end, and
one or more elastic members being provided corresponding to each end bore metal base member and each intermediate bore metal base member.

3. A cylinder bore wall thermal insulator that is provided to a middle-lower part of a groove-like coolant passage of a cylinder block included in an internal combustion engine that includes two cylinder bores, and insulates half of a cylinder bore wall, the cylinder bore wall thermal insulator comprising:
a rubber member that comes in contact with half of a cylinder bore-side wall surface of the middle-lower part of the groove-like coolant passage, and has a contact surface having a shape that conforms to a shape of the cylinder bore-side wall surface of the middle-lower part of the groove-like coolant passage, a metal base member on which the rubber member is secured, and an elastic member that is provided to the metal base member, and biases the metal base member so that the metal base member presses the rubber member against the cylinder bore-side wall surface of the middle-lower part of the groove-like coolant passage,
the rubber member comprising an end bore rubber member that insulates part of the cylinder bore wall that surrounds an end bore that is situated on one end, and an end bore rubber member that insulates part of the cylinder bore wall that surrounds an end bore that is situated on the other end,
the metal base member being integrally formed to cover a range from the part of the cylinder bore wall that surrounds the end bore that is situated on one end to the part of the cylinder bore wall that surrounds the end bore that is situated on the other end, and
one or more elastic members being provided corresponding to each end bore metal base member.

4. The cylinder bore wall thermal insulator according to claim 1,
wherein the metal base member and the elastic member are integrally formed by forming a metal sheet.

5. The cylinder bore wall thermal insulator according to claim 1, further comprising:
a coolant flow adjustment member that is provided at a position near a coolant inlet of the cylinder block, and adjusts a flow of a coolant so that the coolant supplied from outside flows into an upper part of the groove-like coolant passage.

6. The cylinder bore wall thermal insulator according to claim 5, further comprising:
a horizontal rib that is provided to an upper part of the cylinder bore wall thermal insulator so as to extend in a direction in which the coolant flows, and reduces or suppresses a situation in which the coolant that flows through the upper part of the groove-like coolant passage flows into the middle-lower part of the groove-like coolant passage.

7. The cylinder bore wall thermal insulator according to claim 5, further comprising:
a vertical rib that is provided to the cylinder bore wall thermal insulator so as to extend in an upward-downward direction, and reduces or suppresses the flow of the coolant that flows through the middle-lower part of the groove-like coolant passage.

8. An internal combustion engine comprising the cylinder bore wall thermal insulator according to claim 1,
the cylinder bore wall thermal insulator being provided to each of half of the cylinder bore-side wall surface of the middle-lower part of the groove-like coolant passage, and the other half of the cylinder bore-side wall surface of the middle-lower part of the groove-like coolant passage.

9. An internal combustion engine comprising the cylinder bore wall thermal insulator according to claim 1,
the cylinder bore wall thermal insulator being provided to only half of the cylinder bore-side wall surface of the middle-lower part of the groove-like coolant passage.

10. An automobile comprising the internal combustion engine according to claim 8.
